(19) United States
(12) Patent Application Publication
(10) Pub. No.: US 2007/0104207 A1
(43) Pub. Date: May 10, 2007

(54) Selective handling of user equipment

(76) Inventor: Rogier Noldus, Tilburg (NL)

Correspondence Address: ERICSSON INC., 6300 LEGACY DRIVE, M/S EVR 1-C-11, PLANO, TX, 75024, US

(21) Appl. No.: 10/595,040

(22) PCT Filed: Jul. 30, 2004
(86) PCT No.: PCT/EP04/08591

§ 371 Date: Jan. 10, 2006

Related U.S. Application Data
(60) Provisional application No. 60/491,584, filed on Jul. 31, 2003.

(51) Int. Cl. H04L 12/56

(52) U.S. Cl. 370/397

(57) ABSTRACT

The invention relates to a method and device for selective handling of user equipment in a telecommunications network. The method comprises the steps of receiving (S101) a service request, determining (S102, S106, S107) a user equipment identifier, requesting (S103, S108) a user equipment attribute, receiving (S104, S109) the user equipment attribute, and initiating (S111) an appropriate action based on the user equipment attribute.

### FIELD OF THE INVENTION

The invention relates to a method and a device for selective handling of user equipment in a telecommunications network.

### DESCRIPTION OF PRIOR ART

Telecommunications networks such as GSM (Global System for Mobile communications) networks, GPRS (General Packet Radio System) networks or UMTS (Universal Mobile Telecommunication System) networks comprise a database for registering user equipment. The registration of user equipment entails user equipment identification and a permission status of the user equipment. The user equipment identification may be the IMEI (International Mobile Equipment Identity) as specified by 3GPP (3^{rd} Generation Partnership Project) in TS 22.016, V5.0.0, published 2002 Jun. 13.

An example of a database registering user equipment is the EIR (Equipment Identity Register). The EIR comprises three registers, known as ‘white list’, ‘black list’ and ‘grey list’. User equipment assigned to the white list is deemed permitted for use. User equipment assigned to the black list is deemed not permitted for use. User equipment assigned to the grey list is deemed permitted for use, but should be monitored by the network.

A control node may query the EIR to obtain the permission status of a user equipment that is currently registered with the control node. The control node may be a MSC (Mobile Services Switching Centre) in the case of a GSM or UMTS network, or a SGSN (Serving GPRS Support Node) in the case of a GPRS or UMTS network. A network architecture that enables querying the EIR by a control node is specified in 3GPP TS 23.002, V.6.5.0, published 2004 Jun. 23. According to this architecture, messages are exchanged via a so-called F-interface between the MSC and the EIR or via a so-called Gf-interface between the SGSN and the EIR respectively. The Mobile Application Part (MAP) is used as signaling protocol on these interfaces.

Based on the result of the query the control node may decide whether the network accepts the user equipment. In the case of user equipment that is deemed not permitted for use, the control node may not accept registration by the user equipment or it may terminate a call set-up request by the user equipment.

The mechanism for checking the permission status of user equipment according to the state of the art has a number of shortcomings. Once user equipment has registered with a control node and does not perform a location update after registration, the control node will not query the EIR when the user equipment is switched off and on. In the period between detaching from the control node and a subsequent re-attaching to that control node, the subscriber may have changed the SIM (Subscriber Identity Module) from one user equipment to another; this may not be noticed by the control node.

Another shortcoming relates to roaming. If the control node would check the user equipment of an inbound roaming subscriber, i.e. a subscriber visiting the network comprising the control node, the EIR of the visited network may not comprise status information about the user equipment, because the status information may be stored only in the EIR of the home network. Because a control node is normally configured with a single EIR address only, it may not obtain status information for such subscriber.

### SUMMARY OF THE INVENTION

It is an object of the invention to provide an improved way of handling an attribute related to user equipment.

This object is achieved by the method of claim 1 and the Service Control Point of claim 8.

The invention provides a method for selective handling of user equipment implemented in a Service Control Point. The Service Control Point performs the steps of receiving a service request, determining a user equipment identifier, requesting a user equipment attribute, receiving the user equipment attribute and initiating an appropriate action based on the user equipment attribute.

In an embodiment of the invention the user equipment attribute comprises an indication that the user equipment is not permitted for use and the step of initiating an appropriate action based on the user equipment attribute comprises a step of initiating the termination of servicing the user equipment.

In a further embodiment of the invention the user equipment attribute comprises an indication that the user equipment is permitted for use and the step of initiating an appropriate action based on the user equipment attribute comprises a step of continuing servicing the user equipment.

In a further embodiment of the invention the user equipment attribute comprises an indication of a particular deficiency of the user equipment.

In a further embodiment of the invention the step of initiating an appropriate action based on the user equipment attribute comprises a step of initiating an appropriate deficiency handling based on said particular deficiency.

In a further embodiment of the invention the step of determining a user equipment identifier comprises a step of receiving the user equipment identifier in the service request.

In a further embodiment of the invention the step of determining a user equipment identifier comprises the steps of requesting a user equipment identifier from a user equipment and receiving the user equipment identifier from the user equipment.

The invention further provides a Service Control Point for a telecommunications network. The Service Control Point comprises a service handling unit for handling a service request, a processing unit for controlling further units, a user equipment identifier determining unit for determining a user equipment identifier and an interface unit for requesting a user equipment attribute and receiving the user equipment attribute.

In an embodiment of the invention the service control point is adapted to handle a user equipment attribute that comprises an indication that the user equipment is not permitted for use and the Service Control Point further comprises a service termination unit for initiating the termination of servicing the user equipment.

In a further embodiment of the invention the service control point is adapted to handle a user equipment attribute that comprises an indication of a particular deficiency of the user equipment.

In a further embodiment of the invention the Service Control Point further comprises a deficiency handling unit for initiating an appropriate deficiency handling based on the particular deficiency.

In a further embodiment of the invention the service handling unit is arranged to process a user equipment identifier in the service request.

In a further embodiment of the invention the Service Control Point further comprises an interface unit for requesting a user equipment identifier and receiving the user equipment identifier.

### BRIEF DESCRIPTION OF THE DRAWINGS

FIG. 1 depicts a signal flow between entities involved illustrating a possible sequence of steps for selective handling of user equipment according to a first embodiment of the invention.

FIG. 2 depicts a signal flow between entities involved illustrating a possible sequence of steps for selective handling of user equipment according to a second embodiment of the invention.

FIG. 3 depicts a signal flow between entities involved illustrating a possible sequence of steps for selective handling of user equipment according to a third embodiment of the invention.

FIG. 4 depicts a signal flow between entities involved illustrating a possible sequence of steps for selective handling of user equipment according to a fourth embodiment of the invention.

FIG. 5 depicts a Service Control Point according to the invention.

### DETAILED DESCRIPTION OF EMBODIMENTS

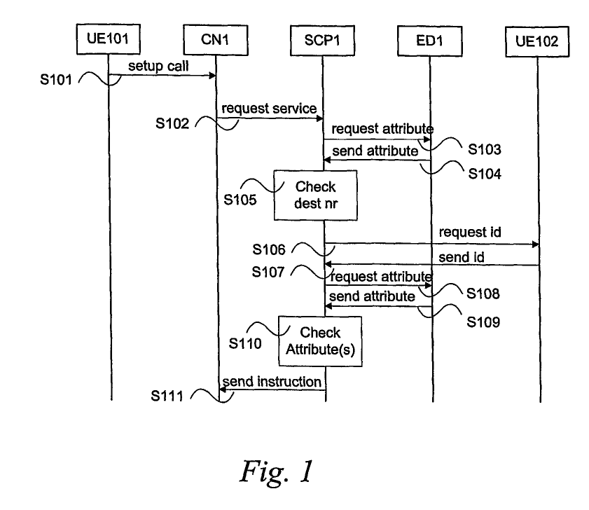

FIG. 1 shows a method for selective handling of user equipment in a telecommunications network according to a first embodiment of the invention. The telecommunications network may be for example a network operating according to GSM, GPRS or UMTS standards. The telecommunications network comprises a control node CN1 that is servicing a subscriber using a user equipment UE101. The control node may be embodied in a MSC (Mobile Services Switching Centre) in the case of a GSM or UMTS network, or in a SGSN (Serving GPRS Support Node) in the case of a GPRS or UMTS network.

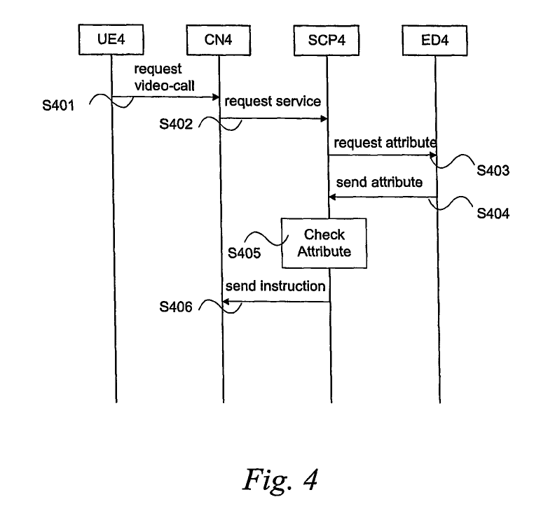

The telecommunications network further comprises a service control point SCP1. The service control point SCP1 comprises service logic and data that allows it to send instructions to the control node CN1. According to the invention, the service control point SCP1 exchanges information with an equipment database ED1 storing user equipment attributes. The equipment database ED1 may also be part of the telecommunications network. The equipment database ED1 may be an Equipment Identity Register (EIR) or another suitable database arranged to store information regarding user equipment. In the case of an EIR the user equipment attributes may comprise indications of a permission status of a particular user equipment. The permission status may indicate that the particular user equipment is ‘black-listed’, i.e. deemed not permitted for use, or ‘white-listed’, i.e. deemed permitted for use, or ‘grey-listed’, i.e. neither ‘black-listed’ nor ‘white-listed’, but use of such user equipment should be tracked by the telecommunications network. In another embodiment of the invention, depicted for example in FIG. 4, the user equipment attributes comprise an indication of a particular deficiency known of the user equipment. Such deficiency may be an implementation of functionality in the user equipment that does not comply with defined telecommunications standards. An example is the registration of implementation faults of early UMTS equipment, as specified in TS25.994, V0.0.0, published 2003 Jan. 06.

The telecommunications network further comprises a further user equipment UE102. For reasons of simplicity the control node servicing user equipment UE102 is not depicted.

In a first step S101 a user equipment UE101 sends a call set-up request to a control node CN1. A user equipment identifier of the user equipment UE101 may be known to the control node CN1. If this is not the case, then the control node CN1 may request the user equipment UE101 to provide the user equipment identifier, not depicted. Preferably the user equipment identifier is the International Mobile Equipment Identifier (IMEI). The call set-up request also comprises a destination number of a called subscriber. Upon receipt of the call set-up request the control node CN1 sends a service request comprising the user equipment identifier and the destination number of the called subscriber to the service control point SCP1 in a step S102. The service control point SCP1 requests an equipment database ED1 to provide a user equipment attribute based on the user equipment identifier in a step S103. In a step S104 the equipment database ED1 sends the user equipment attribute to the service control point SCP1. The user equipment attribute may comprise indications of a permission status of the user equipment. The permission status may indicate that the user equipment is not permitted for use, or is permitted for use. The user equipment attribute may also or instead comprise an indication of a particular deficiency known of the user equipment. Such deficiency may be an implementation of functionality in the user equipment that does not comply with defined telecommunications standards. In the following the check of a permission is described as an example, however, the same steps may be performed when checking for deficiencies.

In a step S105 the service control point SCP1 analyses the destination number to determine whether it belongs to a mobile subscriber. According to this example, the called subscriber is a mobile subscriber using a user equipment UE102. Alternatively, if the called subscriber is not a mobile subscriber, then the following steps S106 to S109 may be omitted. In a step S106 the service control point SCP1 contacts the user equipment UE102 via a Home Location Register and a control node servicing the user equipment UE102, not depicted, to retrieve a user equipment identifier of the called subscriber. In a step S107 the user equipment UE102 sends the user equipment identifier towards the service control point SCP1. In a step S108 the service control point SCP1 requests the equipment database ED1 to provide a user equipment attribute based on the user equipment identifier of UE102. In a step S109 the equipment database ED1 sends the user equipment attribute to the service control point SCP1.

In a step S110 the service control point SCP1 analyses the user equipment attributes of user equipment UE101 and of user equipment UE102 respectively. If either one or both of the equipment attributes of user equipment UE101 or user equipment UE102 indicates that the respective user equipment is not permitted for use, then the service control point SCP1 sends an instruction to the control node CN1 to terminate the call-set up in a step S111. If the user equipment attributes indicate that the user equipment UE101 and the user equipment UE102 are permitted for use, then the service control point SCP1 sends a notification to the control node CN1 to continue call-set up in a step S111.

If the called subscriber is not a mobile subscriber according to the check of step S105, then the service control point SCP1 analyses in step S110 the user equipment attribute of the user equipment UE101 as retrieved in steps S103 and S104. If the user equipment attribute indicates that the user equipment UE101 is not permitted for use, then the service control point SCP1 sends an instruction to the control node CN1 to terminate the call-set up in a step S111. If the user equipment attribute indicates that the user equipment UE101 is permitted for use, then the service control point SCP1 sends a notification to the control node CN1 to continue call-set up in a step S111.

As an alternative to the above-described embodiment the user equipment attributes of user equipment UE101 and UE102 may also relate to particular deficiencies known about the user equipment.

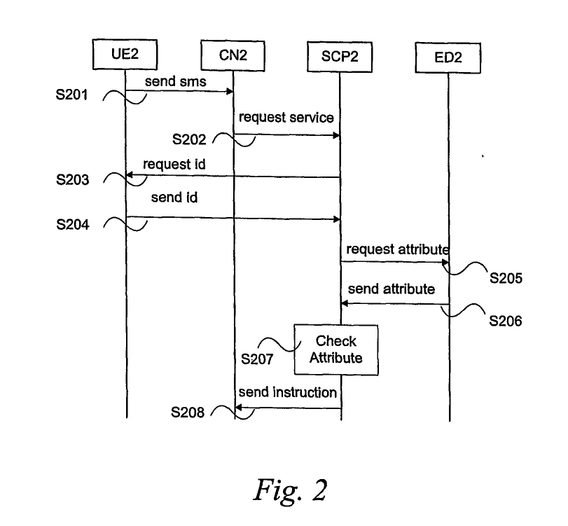

FIG. 2 depicts a further embodiment according to the invention. User equipment UE2, control node CN2, service control point SCP2 and equipment database ED2 are similar to the respective entities as defined in the description of FIG. 1.

In a step S201 a user equipment UE2 sends a short message to a control node CN2. Upon receipt of the short message the control node CN2 sends a service request to a service control point SCP2 in a step S202. In this embodiment the control node CN2 does not include the user equipment identifier of user equipment UE2 in the service request. In a step S203 the service control point SCP2 contacts the user equipment UE2 via a Home Location Register and the control node CN2, to retrieve the user equipment identifier of the user equipment UE2, not depicted. In a step S204 the user equipment UE2 sends the user equipment identifier towards the service control point SCP2. In a step S205 the service control point SCP2 requests an equipment database ED2 to provide a user equipment attribute based on the user equipment identifier of UE2. In a step S206 the equipment database ED2 sends the user equipment attribute to the service control point SCP2.

The service control point SCP2 analyses the user equipment attribute of the user equipment UE2 in step S207. If the user equipment attribute indicates that the user equipment UE2 is not permitted for use, then the service control point SCP2 sends an instruction to the control node CN2 to terminate the short message transmission in a step S208. If the user equipment attribute indicates that the user equipment UE2 is permitted for use, then the service control point SCP2 sends a notification to the control node CN2 to continue the short message transmission in a step 208.

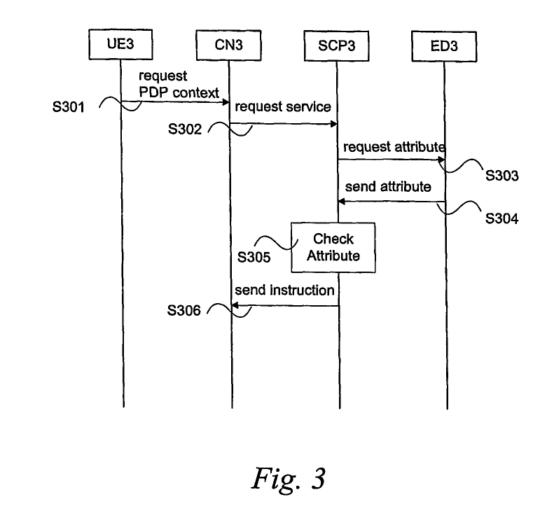

FIG. 3 depicts a further embodiment according to the invention. In this embodiment control node CN3 is a SGSN and equipment database ED3 is an EIR.

In a step S301 a user equipment UE3 sends a request for Packet Data Protocol (PDP) context establishment to a control node CN3. Upon receipt of the request the control node CN3 sends a service request comprising the user equipment identifier of UE3 to a service control point SCP3 in a step S302. In a step S303 the service control point SCP3 requests an equipment database ED3 to provide a user equipment attribute based on the user equipment identifier of UE3. In a step S304 the equipment database ED3 sends the user equipment attribute to the service control point SCP3.

The service control point SCP3 analyses the user equipment attribute of the user equipment UE3 in step S305. If the user equipment attribute indicates that the user equipment UE3 is not permitted for use, then the service control point SCP3 sends an instruction to the control node CN3 to terminate the PDP context establishment in a step S306. If the user equipment attribute indicates that the user equipment UE3 is permitted for use, then the service control point SCP3 sends a notification to the control node CN3 to continue the PDP context establishment in a step 306.

FIG. 4 depicts a further embodiment according to the invention. In this embodiment control node CN4 is a MSC and equipment database ED4 registers user equipment attributes comprising indications of deficiencies of user equipment.

In a step S401 a user equipment UE4 sends a request for a video call to a control node CN4. Upon receipt of the request the control node CN4 sends a service request comprising the user equipment identifier of UE4 to a service control point SCP4 in a step S402. In a step S403 the service control point SCP4 requests an equipment database ED4 to provide a user equipment attribute based on the user equipment identifier of UE4. In a step S404 the equipment database ED4 sends the user equipment attribute to the service control point SCP4.

The service control point SCP4 analyses the user equipment attribute of the user equipment UE4 in step S405. If the user equipment attribute indicates that the user equipment UE4 has a deficiency that does support to set up a video call, or not in the requested way, then the service control point SCP4 sends an instruction to the control node CN4 to fall back to a speech call in a step S406. If the user equipment attribute indicates that the user equipment UE4 has no such deficiency, then the service control point SCP4 sends a notification to the control node CN4 to continue the request for a video call in a step 406.

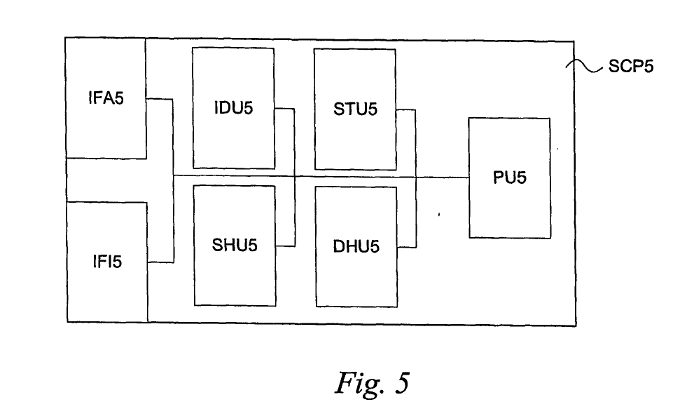

In FIG. 5 a service control point SCP5 according to an embodiment of the invention is depicted. The service control point SCP 5 comprises a service handling unit SHU5 for handling a service request, a processing unit PU5 for controlling further units, a user equipment identifier determining unit IDU5 for determining a user equipment identifier, an interface unit IFI5 for requesting a user equipment identifier and receiving the user equipment identifier, an interface unit IFA5 for requesting a user equipment attribute and receiving the user equipment attribute, a service termination unit STU5 for initiating the termination of servicing a user equipment and a deficiency handling unit DHU5 for initiating an appropriate deficiency handling based on a particular deficiency. Via the interface unit IFI5 the service control point SCP5 contacts a user equipment, e.g. via a HLR Home Location Register and a control node servicing the user equipment. Via the interface unit IFA5 the service control point SCP5 interfaces with one or more external databases comprising user equipment attributes. Each of the units SHU5, PU5, IDU5, IFI5, IFA5, STU5 and DHU5 can be implemented in hardware or software or a combination of both.

According to an embodiment of the invention, the service handling unit SHU5 receives a service request. The service request comprises a user equipment identifier of a user equipment of a calling subscriber and preferably a destination number of a called subscriber. Via the interface unit IFA5 the processing unit requests an external database to provide a user equipment attribute based on the user equipment identifier of the user equipment of the calling subscriber. The interface unit IFA5 receives the user equipment attribute from the external database. According to an embodiment of the invention the processing unit analyses the destination number of the called subscriber. If the called subscriber is a mobile subscriber, then the user equipment identifier determining unit IDU5 contacts the user equipment of the called subscriber via the interface unit IFI5 to request the user equipment identifier of the user equipment of the called subscriber. The interface unit IFI5 receives the user equipment identifier of the user equipment of the called subscriber. The processing unit requests an external database via interface unit IFA5 to provide a user equipment attribute based on the user equipment identifier of the user equipment of the called subscriber. The external database might be the same database as contacted in the case of the calling subscriber or a different database. The choice of external database depends on the user equipment identifier of the user equipment for which the user equipment attribute is retrieved. The interface unit IFA5 receives the user equipment attribute of the user equipment of the called subscriber from the external database. The processing unit analyses the user equipment attributes of the user equipments of the calling and called subscriber respectively. If in a particular embodiment of the invention, either one or both of the user equipment attributes of the calling or called subscriber indicates that the respective user equipment is not permitted for use, then the service termination unit STU5 initiates the termination of servicing the user equipment, e.g. by sending an instruction to a control node to terminate a request for call set-up. If the user equipment attributes indicate that both the user equipment of the calling and the user equipment of the called subscriber are permitted for use, then the processing unit sends a notification to a control node to continue e.g. a request for call-set up.

If in a further particular embodiment of the invention, the user equipment attribute of the user equipment of the calling or called subscriber comprises an indication of a particular deficiency known of the user equipment, then the deficiency handling unit DHU5 analyses the indication of the particular deficiency and initiates an appropriate deficiency handling based on said particular deficiency, e.g. by sending an instruction to a control node to disallow a request for a video call and allow a speech call only for the user equipment.

1-13. (canceled)

14. A method for selective handling of user equipment in a telecommunications network, wherein a Service Control Point (SCP) performs the steps of:
receiving a service request;
determining a user equipment identifier;
requesting a user equipment attribute relating to permission or deficiency status information of the user equipment;
receiving the user equipment attribute; and,
initiating a predetermined action based on the user equipment attribute.

15. The method recited in claim 14, wherein the user equipment attribute comprises an indication that the user equipment is not permitted for use and wherein the step of initiating a predetermined action based on the user equipment attribute comprises the step of initiating the termination of service to the user equipment.

16. The method recited in claim 14, wherein the user equipment attribute comprises an indication that the user equipment is permitted for use and wherein the step of initiating a predetermined action based on the user equipment attribute comprises the step of continuing service to the user equipment.

17. The method recited in claim 14, wherein the user equipment attribute comprises an indication of a particular deficiency of the user equipment.

18. The method recited in claim 17, wherein the step of initiating a predetermined action based on the user equipment attribute comprises the step of initiating deficiency handling process based on said particular deficiency.

19. The method recited in claim 14, wherein the step of determining a user equipment identifier comprises the step of receiving the user equipment identifier in the service request.

20. The method recited in claim 19, wherein the step of determining a user equipment identifier comprises the steps of:
requesting a user equipment identifier from a user equipment; and,
receiving the user equipment identifier from the user equipment.

21. A Service Control Point for a telecommunications network, comprising:
a service handling unit for handling a service request;
a processing unit for controlling further units;
a user equipment identifier determining unit for determining a user equipment identifier; and,
an interface unit for requesting a user equipment attribute relating to permission or deficiency status information of the user equipment and for receiving the user equipment attribute.

22. The Service Control Point recited in claim 21, wherein the Service Control Point is adapted to handle a user equipment attribute that comprises an indication that the user equipment is not permitted for use and wherein the Service Control Point further comprises a service termination unit for initiating the termination of service to the user equipment.

23. The Service Control Point recited in claim 21, wherein the Service Control Point is adapted to handle a user equipment attribute that comprises an indication of a particular deficiency of the user equipment.

24. The Service Control Point recited in claim 23, wherein the Service Control Point further comprises a deficiency handling unit for initiating a deficiency handling process based on the particular deficiency.

25. The Service Control Point recited in claim 21, wherein the service handling unit is adapted to process a user equipment identifier in the service request.

26. The Service Control Point recited in claim 21, wherein the Service Control Point further comprises an interface unit for requesting a user equipment identifier and for receiving the user equipment identifier.
